(19) United States
(12) Patent Application Publication
(10) Pub. No.: US 2006/0080198 A1
(43) Pub. Date: Apr. 13, 2006

(54) CASH TRANSACTION SYSTEM

(76) Inventor: Brian J. Doyle, Victoria (CA)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/161,242

(22) Filed: Jul. 27, 2005

Related U.S. Application Data
(63) Continuation-in-part of application No. 10/950,537, filed on Sep. 28, 2004.

(51) Int. Cl. G06Q 40/00

(52) U.S. Cl. 705/35

(57) ABSTRACT

A cash avoidance system uses an identifier associated with a hardware token such as a card to establish an account. Change from cash transactions are credited to the account to be spent for future purchases anonymously. The person in possession of the card may then debit the account to purchase goods and services. The transactions may be carried out over a mesh network.

### CROSS-REFERENCE TO RELATED APPLICATION

This application is a continuation-in-part of U.S. application Ser. No. 10/950,537 filed Sep. 28, 2004, the content of which is hereby incorporated by reference.

### BACKGROUND OF THE INVENTION

It is customary for consumers to have many different types of magnetically readable cards, such as membership cards, debit cards, credit cards, discount cards, prepaid cards, etc. Each business or organization that uses a card has an interest in having their own card issued for advertising purposes as well as obtaining demographic information about their customers. However, there is a growing sentiment that there are too many cards being issued, which causes undue waste, and there are people who wish to keep personal information private. In addition, some small businesses who could benefit from the convenience of a card cannot afford to issue one. This invention relates to a method of using existing cards to address these issues.

### SUMMARY OF THE INVENTION

This patent document describes the Veyu™ payment system. According to an aspect of the invention, the Veyu™ payment system provides a method of completing a financial transaction, the method comprising the steps of creating an identifier relating to a person who is paying for one or more products or services having a purchase price with a tendered amount of cash that is in excess of the purchase price, leaving due to the person, transmitting the identifier, the purchase price and the tendered amount to a server; and crediting an account associated with the identifier with all or a portion of the change. The method may further comprise the step of debiting the account during a purchase carried out by a person who has some means to generate the identifier. The identifier may be an alpha-numeric code created from a number associated with a card, such as an identification card or a financial card, carried by the person.

According to a further aspect of the invention there may be a provided a record stored in a computer readable storage medium, the record comprising a personal identifier; and an asset identifier, where the asset identifier comprises amounts of change obtained from multiple transactions where the amount of cash tendered in a transaction exceeded the sale price of the transaction.

According to various aspects of the invention, the identifier may be biometric data, or a unique identity number derived from a number encoded on a card carried by the person such as an identification card, for example a social security card or student ID card, or a financial card, such as a credit or debit card.

According to an aspect of the invention, the Veyu™ payment system may operate over a wireless self-healing mesh network or any other communication network, and may be combined with one or more ancillary or “tag services” to the core transaction service. The Veyu™ payment system enhances convenience and reduces costs to minimal levels while at the same time ensuring that adequate safe guards remain in place to guarantee security of transaction. The Veyu™ payment system may use current infrastructure, and reduces possible regulatory compliance costs.

The Veyu™ payment system does not require pre-registration or enrollment of the consumer prior to use of the system, and utilizes existing services on third party issued cards and the millions of existing point of sale terminals on sales counters around the world. The Veyu™ payment system eliminates the need to make or carry change, and provides anonymity to all customers, making the system equivalent to a cash payment system. The Veyu™ payment system may provide debit card characteristics more appropriate to some cultures than credit, reduces risk of consumer non-payment, and allows banking without having to open a bank account.

Other aspects of the invention will become apparent from the claims, which are incorporated here by reference.

### BRIEF DESCRIPTION OF THE DRAWINGS

There will now be given a brief description of preferred embodiments of the invention, with reference to the drawings, by way of illustration only and not limiting the scope of the invention, in which like numerals refer to like elements, and in which:

FIGS. 1A and 1B are flow charts representing the steps of an embodiment of the invention;

FIG. 2 shows the fields of a record of a Veyu™ payment system account stored at a server;

FIG. 3 is an example of the bit sequence of a transaction; and

FIG. 4 is a block diagram of the hardware used in an embodiment of the invention.

### DETAILED DESCRIPTION OF THE DRAWINGS

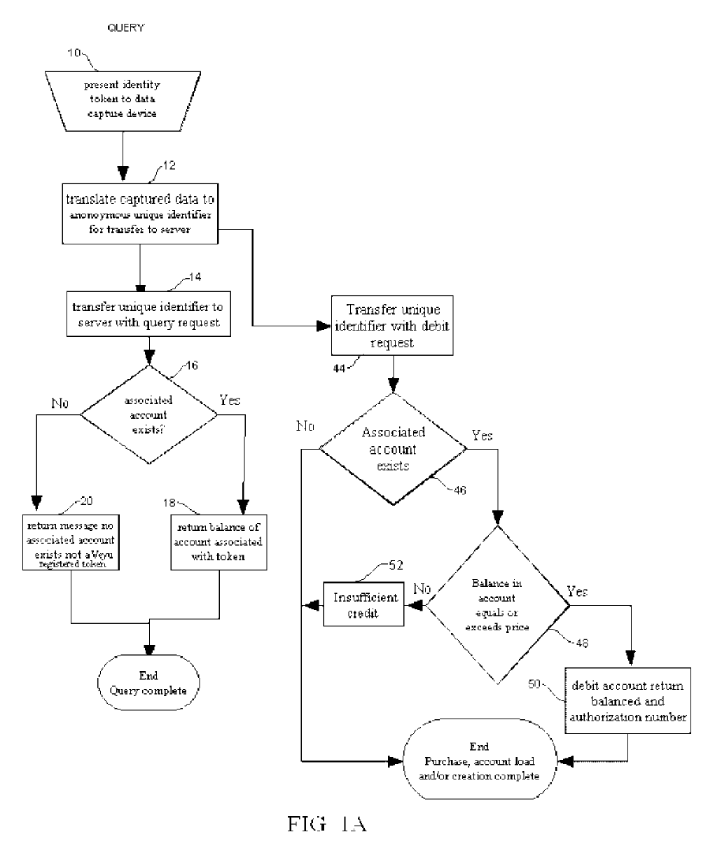

The term card refers generally to cards with a unique signature, such as a number to identify that card, but also refers to any type of electronic card now known or created in the future having the same function as currently used credit, security or identification cards. The electronic card may be a thin plastic card with an electronically readable strip such as a magnetically readable strip, or may be an electronic chip of any configuration either as a stand alone unit or associated with, such as by embedding in, some other medium. Exemplary electronic cards include a credit card issued by a bank with a magnetically readable strip on the back, or a magnetically readable student identification card issued by an educational institution. It will be recognized that other types of devices carrying unique signatures may be designed in the future. While the description herein will use a card with a magnetically readable strip on the back and the number printed on the front as the preferred embodiment, a person skilled in the art will recognize that the teachings may be adapted to other situations. The customer or person using a Veyu™ payment system at a remote terminal may be any legal entity capable of carrying on a transaction in commerce, but will typically be an individual. A merchant is any legal entity that is capable of carrying on a transaction in commerce, and will typically be a company involved in the sale of goods and services. A transaction is any exchange of goods and services, whether or not for consideration. Account manager 10 as defined herein includes any individual, business, or other entity; or group or affiliation of individuals, businesses or other entities, that facilitates the processes of the present invention. A server as used in the Veyu™ payment system may comprise many sub-components, subsystems and/or a variety of business entities, whether open loop or closed loop. The Veyu™ payment system may be one system, distributed systems or any other arrangement of systems in any form, such as software, hardware, etc. The network over which the Veyu™ transactions take place may be any computerized network that allows for the exchange of analog or digital information. The server and remote terminal will include the necessary software to facilitate communication between the server and remote terminal. The network and server may comprise various computer web and application servers, databases, routers, relays and the like in order to suitably process, route, and transmit data from the remote terminal to the server. While a specific flow chart is shown in FIGS. 1A and 1B, various methods may be used to capture, transform and transfer an identifier and verify account existence and status, and various interrelations of the query, purchase and load value sub-processes may be used. Specific commands and messages generated by the remote terminal and the server will depend on the specific embodiment of the invention employed.

The Veyu™ payment system enrolls merchants to their payment system by entering into an agreement with the merchant to provide Veyu™ payment system services which stipulates the terms and conditions as well as the technical parameters (or protocols) for conducting a mini transaction. Veyu™ payment system uses standard secure internet protocol for all transaction so a pre-requisite for the merchant enrollment is internet enabled sales devices able to connect to a wireless mesh network supplied by a Veyu™ payment system provider or as a minimum access to the internet at large. The Veyu™ payment system provider may use various POS (point of sale) software suppliers to add a software module allowing Veyu™ payment system as simply another payment method alongside traditional services such as VISA™, CIRRUS™ and other debit and credit services.

A patron of a Veyu™ payment system merchant when tendering cash for a purchase may request that they receive their change virtually on a card of their choice. Such a patron may be any legal person entitled to carry on a cash transaction in the country of interest. The card will typically be an ISO standard card with some sort of embossed or printed account number and each and every transaction receives an authorization number displayed or printed at the point of sale. Upon swiping the card a unique electronic signature is derived from the data captured from the card and this signature is stored in the Veyu™ payment system database along with the amount of credit being the change due the customer minus a Veyu™ payment system service fee. The identifier captured from the card does not need to be, and preferably is not, stored in the Veyu™ payment system database. The transaction therefore remains anonymous. No special registration or card is required by the customer. No specific reload equipment is required by Veyu™ payment system and it is extremely convenient for both parties to the transaction not to have to deal with small change. The exact protocol used for transactions and the associated security measures is a matter of choice for the Veyu™ payment system provider but may use normal mesh routing to perform various operations such as query (FIG. 1A), debit (FIG. 1B) and credit (FIG. 1B), and change. Change is used to conduct currency exchange or transaction in a different currency from the quoted sale price, and may occur during either a debit or credit transaction since for example a purchase may be made with a tender in a different currency from the currency used by a merchant in its quoted price. Mini payments can be conducted in any currency in real time. A credit transaction may occur as a credit to an existing account or may include creating an account and crediting the account in the same transaction. As mentioned every transaction causes the issuance of an authorization number and the authorization number and the card number can be used on the Veyu™ payment system website to link a card to an account which allows several additional “tag services” to be utilized often without diminishing the users anonymity. Once a card has been linked to an account, “tag services” such as transferring value between cards and loading value to the Veyu™ payment system purse using a regular credit or debit card can be used independent of any PIN.

After a card has been initiated into the Veyu™ payment system by its first time use the balance linked to the card can be spent or topped up at any Veyu™ payment system merchant at any time. The “back office” database simply maintains the account balance and deducts the appropriate fees automatically using standard secure internet protocol to communicate with devices in the field in real time. There are no billing procedures, no statements or collections and no bad debt as all purchases are pre-paid and all Veyu™ payment system fees are simply debited from applied credits at the time of transaction. Nothing is actually stored on the card used at the point-of-sale device. There are no visible indications that any particular card is being used as a Veyu™ payment system card, and actual or real account numbers are never transmitted or stored on Veyu™ payment system servers. A prescribed limit as to the amount of credit which can be placed upon a card will be set periodically to avoid regulatory compliance issues with regards to the taking of financial deposits. Absolutely no personal information need be collected or stored by Veyu™ payment system on its servers so no regulatory compliance costs associated with privacy legislation to protect an individual's data is required.

Veyu™ payment system may offer additional services tagged onto the core services. These “tag services” such as any number of special merchant or reward programs may be offered to not only large multinational chains but also the smallest of merchants. These reward and point system need not be national in scope and can be self administered by the merchants by visiting the Veyu™ payment system website. For example a single noodle shop in China would find it beneficial to enroll as a Veyu™ payment system merchant for an number of reasons, reduce the cost of handling “change”, reduce the transaction costs of accepting credit cards, encourage repeat customers the mainstay of many small merchant's business, reduce pilferage by staff etc. but importantly without great fanfare, without special cards and independent of any owned system to track customer purchases be able to offer flexible cost effective merchant promotions such as providing the 10th bowl of noodles free. Since these “tag services” can be self administrated by enrolled merchants at no additional costs they represent a real value add allowing small merchants some of the types of marketing initiatives and power normally reserved for larger corporations.

Veyu™ payment system enabled terminals in any given territory may provide the ability to transact in additional currencies. For example a POS device in Mexico would have the Peso as it default currency but may also list the US dollar, the Canadian dollar, the Euro, the Columbian Peso and the Japanese Yen as alternate acceptable payment currencies. By seamlessly allowing a variety of currencies to be used for mini payments we eliminate one of the inconveniences of travelers which is in a word coinage. Unfamiliar coins which invariably ends up in the bottom of a suitcase or deposited in a charity box at the airport upon one's return home have been the bane of travelers since the advent of universal and frequent travel precipitated by the jet plane and low fares. The Veyu™ payment system permits travel from Singapore into Malaysia and spending Singapore dollars in Malaysia while having the change stored virtually as Ringgits to spend while in Malaysia. Upon return home the balance in the traveller's Veyu™ payment system account is automatically converted back into Singaporean dollars.

The Veyu™ payment system may provide accurate accounting in the form of a detailed statement e-mailed each month for even mini payments. The Veyu™ payment systems may also allow transfer of account balances between Veyu™ payment system patrons (such as between family members). Such account transfers may be carried out by e-mail or at a point-of-sale device that has been programmed for the purpose. For example, a person receiving change at a Veyu™ payment system terminal may specify one or more other recipients of the change, or may transfer some or all of their stored balance at the Veyu™ payment system server to another Veyu™ payment system user. The Veyu™ payment system may also offer automatic transaction location information, when used with Mesh or Ad Hoc networks, since the location of the terminal within the network can be derived from fixed terminals or nodes in the net work. This service is independent of any satellite or GPS based system and avoids the additional costs of GPS receivers.

Veyu™ payment service may also provide direct competition to other online payment systems such as Pay Pal. Unlike Pay Pal which effectively adds additional layers and costs to regular credit card transaction processes to allow peer to peer transactions in the absence of either party being a Visa merchant, Veyu's online payments would remain independent and cost effective as the method of loading value to an account is bank independent. Numerous other tag services are possible since all control and software function resides with the server at the heart of the system. By choosing industry standards and a totally flexible platform Veyu's payment system may evolve and mutate as the very internet system upon which it relies. Today it may draw its strengths from the prevalence of magnetic cards and readers whereas tomorrow it may use smart chip cards to deliver its punch. The security of transaction will automatically ascend with the worldwide efforts to make the internet a safer place to conduct commerce.

Referring to FIGS. 1A and 1B, a specific detailed Veyu™ payment system transaction at a remote terminal will now be described. The transaction shown in FIGS. 1A and 1B has three parts. First, it is determined whether an account exists, and if not, then the account is created (FIG. 1A). Second, an amount is credited to the account (FIG. 1B). Third, the balance in the account is used for a purpose, which may simply be a purchase from a Veyu™ payment system merchant with a corresponding debit of the account (FIGS. 1A and 1B). In FIG. 1A, the basic steps of a query are set out. First, the customer informs the Veyu™ payment system merchant that a query of the system is requested, or the customer desires to open an account. The customer is then asked to swipe a card, which could be any card, at step 10 or provide other identification information as described herein. In step 12, the captured number is transformed into an anonymous unique identifier by a mathematical operation carried out on the number. This process creates an identifier for the person making the purchase. This step occurs at a remote Veyu™ payment system terminal, which may be a third party terminal modified with appropriate software to carry out the Veyu™ payment system method steps or may be a specifically designed Veyu™ payment system terminal designed to carry out the process steps described here. The identifier may be any unique identifier relating to the person, including biometric data. The identifier may be created from a number on a card, such as an identification card or financial card carried by the person. The identifier may for example be a mathematical translation, hash or encrypted version of the number on the card. For example, the identifier may be generated from a translation table. For example, a number 4 on the card might be replaced by a lower case “a”, or a 6 by an upper case “G”, and so on. In another example, the identifier may be a hash of a credit card number, obtained for example by swiping the card through a card reader and transforming the read number using a hashing algorithm. The use of a unique identifier created at the sale point avoids storing personal information within the Veyu™ payment system network. Under some circumstances, if anonymity and collection of private information is not an issue biometric data or a credit card number may be used without transformation. The information may be derived from the data encoded on a card and thus obtained by, for example, swiping a card through a card reader, or by entering the information manually.

For a query, the unique identifier is transferred at step 16 to a remote Veyu™ payment system server with the query request. The server then responds to the request with an account balance at step 18 if an account exists corresponding to the identifier, or a message indicating no account exists at step 20 if there is no account associated with the identifier.

Crediting an account may occur in two ways according to the example shown in FIGS. 1A and 1B. When a customer at a Veyu™ payment system terminal makes a purchase, the particulars of the purchase are entered into the terminal at step 22 and the customer is asked how they would like to pay, cash or Veyu™ payment system, at step 24. If the customer chooses cash, then the amount of cash tendered is entered at step 26. The merchant then requests a credit transaction from the server at step 28. A check is made at step 30 to check that the amount tendered exceeds the purchase price. If the amount tendered does not exceed the purchase price, the customer is asked again for an amount to be tendered. If the amount tendered exceeds the purchase price, then the customer and system follow steps 10 and 12 to obtain a unique identifier, which is transferred to the server along with the credit request at step 32. The server checks whether an account associated with the identifier exists at step 34. If the account does not exist, then steps 10 and 12 are repeated at step 36 and an account is created at step 38. Once the account is created, or if the account is found already to exist after step 34, then at step 40 the account is credited with the change, that is, the excess of amount tendered over the purchase price, the balance is returned to the terminal for the customer to check if they wish, and an authorization code is generated that is captured by both the server and the remote terminal. In the normal case, all of the change will be credited to the account, but it is possible to credit the account with only a portion of the change, for example, the coin portion of a tender that has the form of coins and paper currency.

In a second exemplary method of loading value into an account, a customer at a remote Veyu™ payment system terminal (which could for example be a terminal at a merchant, or a computer at a customer's home with Veyu™ payment system software) indicates that a credit transaction is desired and, if at a merchant's terminal, the price defaults to zero, at step 42. The customer then enters an amount to be tendered at step 26 and the same process is followed as for loading an account with change from a transaction.

To carry out a subsequent purchase using the balance in the account, the customer follows steps 22 and 24 in FIG. 1B, but chooses Veyu™ payment system in step 24 and is led through steps 10 and 12 to create a unique identifier, which is then transmitted in step 44 to the remote server along with the purchase price and type of currency tendered specifying the transaction type as “debit. The server then checks whether an account exists at step 46. If the account exists, then the server checks at step 48 whether the balance in the account exceeds the purchase amount. If the balance in the account exceeds the purchase amount, then the account is debited with the purchase amount at step 50 and the balance in the account is returned in a message to the customer with an authorization number that is captured by the merchant and the Veyu™ payment system server. In case of approval of the transaction, the vendor is credited with the amount of the purchase minus a small fee. If the account does not exist, or the balance in the account does not equal or exceed the purchase price such that there is insufficient credit at step 52, the transaction is at an end, and the customer may be invited to create an account and provide it with a balance by suitable means, such as following the steps from step 42.

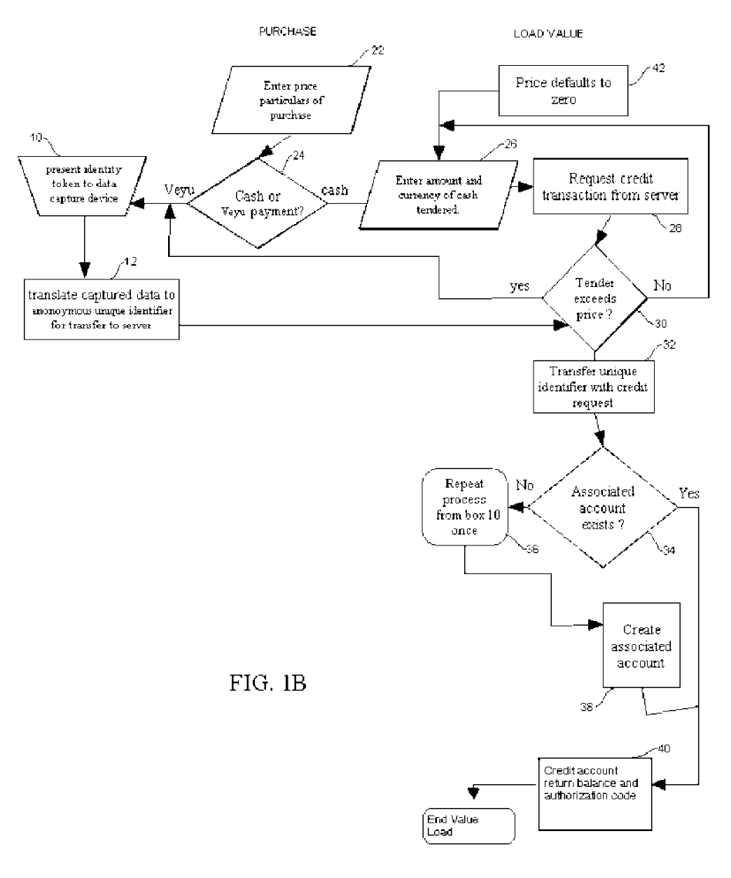

In each of the transfers steps 14, 32 and 44, the unique identifier is transmitted with other relevant data; for example in the case of the credit transaction, the Veyu assigned terminal identifier, the purchase price and currency, and the tender amount and currency to a remote server. In general, if there is no account at the remote server associated with the identifier, then an account is created with a balance equal to the change minus a small transaction fee. If an account exist for the unique identifier then the amount of change is credited to the account. For the special case where the purchase price and the tender amount transmitted with the unique identifier are both zero the transaction is considered by the server as a Query and either the balance is returned or a message that the associated electronic signature has not been registered or used in the Veyu system. At the same time, a fee is deducted from the account to pay for the transaction. The fee may be only a few cents and is credited to the Veyu™ payment system service provider. The merchant may also be credited with a fee deducted from the account. A record of the account stored at the server for every transaction will constitute fields showing the unique identifier 60, the terminal identifier 62, the date 64 and the account balance 66 as shown for example in FIG. 2. etc as shown by Veyu™ payment system Protocol disclosed herein. By using a simple translation table, the information read electronically from the card is translated into an unique identifier prior to being transmitted or stored on the server, no personal information need be associated with the account stored at the server.

In general, the transaction and transmission of the unique identifier derived from the data encoded on the third party issued card will not be carried out by or with the authorization of the card issuer. The identifier and record are preferably stored on a remote server, accessible through a network, which is preferably a self-healing mesh network. Since the card number is unique, there is no need to record any further personal information, the type of card or the card issuer, unless the customer wished to register a record with the server to allow tag services. Generally only the card is required to conduct a transaction either crediting additional sums of change to the remote account or debiting sums from the associated account in the form of a purchase. The holder of the card may then access the record and the assets associated with the record using the information on the card, and then debit the account to make a purchase at a Veyu™ payment system merchant.

The Veyu™ payment system may permit additional transactions to be selected as the transaction type other than a simple debit of the account to make a cash purchase. Such transactions may include on line reloading of value to the card, transfers of value from one card associated with the record to another card associated with the record and or transmission of financial gifts to other cards and/or records whether registered or to be registered. The transaction may also be a further credit of change to the account or a debit to pay for a purchase of goods or services.

Other transactions may include depositing money to create a financial balance in the record such that the card may be used as a stored value card. There are different ways of doing this. For example, money may be deposited as cash with a machine such as a bill acceptor connected to the server, over the internet, by telephone, or with a merchant at a point of sale. When practical, cash may used to create the financial balance, or money may also be moved using a credit or debit card, or other means commonly used to transfer money. Software packages that make these transactions possible are well known in the art. To use the stored value, the user swipes the card at a point of sale and the transaction amount would be debited from the record. Preferably, the transactions would not be for large sums of money, with limits applied if required. Once the balance reached a certain level, the user may be warned that the funds are nearly depleted, in which case money may be applied to the record. This may be useful for paid parking, pay phones, public transit, toll booths, car washes, or stores where small purchases are made, such as coffee shops, fast food restaurants, or grocery stores.

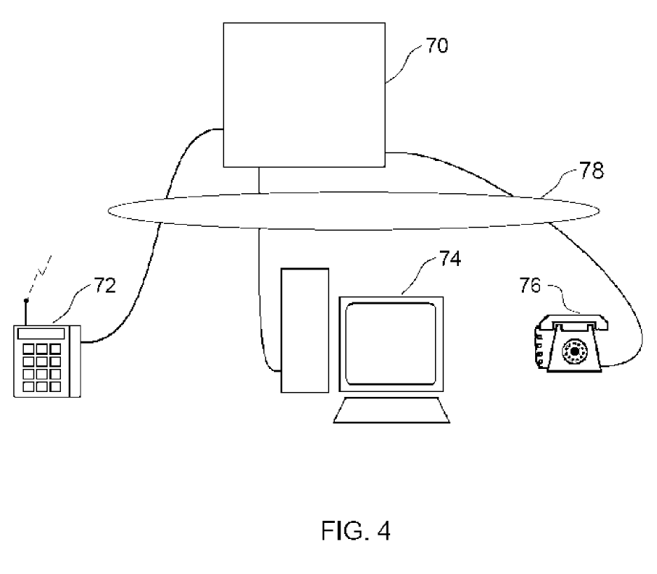

As mentioned above, and referring to FIG. 4, the server 70 storing the record may be accessed from remote locations such as by using a point of sale reader 72, an internet connection 74 by going to a web page designed for that purpose, or a telephone connection 76 by calling a designated phone number. The services available may include checking the balance, transferring funds, or replacing the number associated with the record to another number, for example, if the magnetic strip on the back became unreadable, or if the card had been lost or stolen and a record of the number was kept. It may be necessary to password protect the information to prevent unauthorized access to the balance, which could be done at the time the record was created. When a password is used, the record at the server 70 will also include the password.

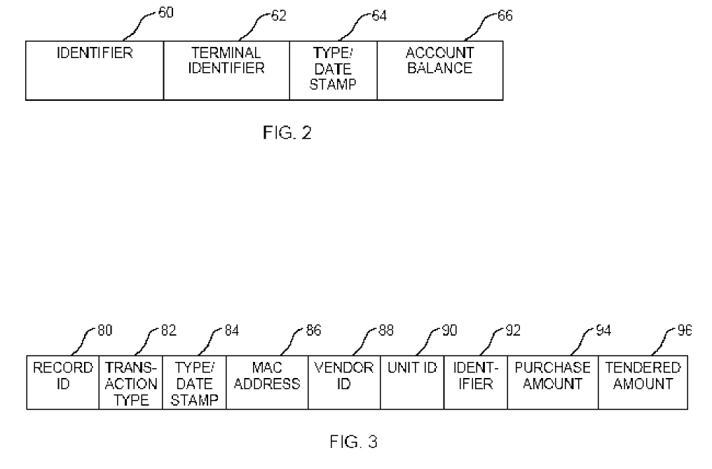

An example of a bit structure of a transmission from a remote Veyu™ payment system terminal to a Veyu™ payment system server that may be used is shown in FIG. 3. This structure may be modified depending upon the situations required. The record shown here includes a series of fields that identify a record ID 80, transaction type 82, time/date stamp 84, MAC address 86, vendor ID 88, unit ID 90, identifier 92, purchase amount 94 and tendered amount 96. The record ID 80 may be a number generated sequentially for each transaction. The transaction type 82 may be one of four options: query, credit, debit or change. A query transaction is used to see if an account exists with the corresponding identifier and to learn the current balance as stored on the server. A credit transaction is used to credit the account balance with the difference between the purchase amount and the tendered amount (if it is positive). A debit transaction is used for purchase, in which case the purchase amount is shown and the tendered amount is null. A change transaction is used to convert the balance in the account from one currency to another. The time/date stamp 84 identifies the time and date of the transaction at the remote terminal. The MAC address 86 specifies the address of the remote terminal in the network. The vendor ID 88 identifies the vendor. The unit ID 90 identifies the particular remote terminal used for the transaction. The identifier 92 is as described above. The purchase amount 94 and tendered amount 96 are also transmitted, although a single field could be used showing just the difference, for a credit, or the purchase amount, for a debit. Currency identifiers (not shown) are included in the record both to identify the currency for the purchase amount 94 and the currency for the tendered amount 96, each of which currencies may be different. The costs associated with implementing a card-based program are reduced significantly as there are no cards to be purchased, and no costs associated with distributing and maintaining distribution lists and card services departments. Because the operating costs are low, it is possible to charge less per transaction, making it more attractive to merchants. Depending upon the situation, the method may require the distribution of some point of sale devices 72. These devices 72 may be wireless as shown in FIG. 4 for situations where there isn't already an internet connection, and can operate on unlicensed and free bandwidth such as 80211i or Wi-Max which are becoming increasingly popular. In other situations, the business or organization that is using the system may find it more practical to license the software for their own server in addition to connecting to a central server. This would be acceptable provided transaction records were forwarded, or relayed, to the central Veyu server in real time to permit for an accurate trusted and universal payment system.

The remote terminals may communicate with the server 70 through a mesh network 78 in which the nodes of the network each discover the topology and route messages without being centrally controlled. Such mesh networks may be robust in that they are self-healing. If one portion of the network is severed, the nodes themselves detect the failed link or node and route messages around the failed link or node. A variety of self-healing networks are known in the patent literature such as in U.S. Pat. No. 6,856,592 issued Feb. 15, 2005, the content of which is hereby incorporated by reference.

Immaterial modifications may be made to the embodiments described in this disclosure without departing from the invention.

What is claimed is:

1. A method of completing a financial transaction, the method comprising the steps of:
creating an identifier relating to a person who is paying for one or more products or services having a purchase price with a tendered amount of cash that is in excess of the purchase price, leaving change due to the person;
transmitting the identifier, the purchase price and the tendered amount to a server; and
crediting an account associated with the identifier with all or a portion of the change.

2. The method of claim 1 further comprising the step of debiting the account during a purchase.

3. The method of claim 1 in which the identifier is biometric data.

4. The method of claim 1 in which the identifier comprises a unique identifier derived from a number associated with a card carried by the person.

5. The method of claim 4 in which the card is one of a driver's license, student card, health card, and a financial card.

6. The method of claim 5 in which the identifier is derived from the numbers obtained when swiping a magnetic card.

7. The method of claim 1 in which transmission of the identifier is carried out over a mesh network.

8. A record stored in a computer readable storage medium, the record comprising:
a unique identifier; and
an asset identifier, where the asset identifier comprises amounts of change obtained from an aggregation of multiple transactions where the amount of cash tendered in a transaction exceeded the sale price of the transaction.

9. The record of claim 8 in which the unique identifier is derived from a number on one of a driver's license, student card, health card, and a financial card.

10. The record of claim 8 in which the asset identifier includes amounts deposited or reloaded apart from change from a purchase transaction.

11. The record of claim 8 wherein the identifier is derived from electronically readable information from an electronically readable card.

12. The record of claim 8 where the identifier is or is derived from biometric data.
